(19) United States
(12) Patent Application Publication
(10) Pub. No.: US 2026/0078829 A1
(43) Pub. Date: Mar. 19, 2026

(54) Valve device, thermal management system, use and method

(71) Applicant: BTT Solutions GER GmbH, Kornwestheim (DE)

(72) Inventors: Bert Hiller, Weinstadt (DE); Thomas Misskam, Eberdingen (DE)

(21) Appl. No.: 19/325,642

(22) Filed: Sep. 11, 2025

(30) Foreign Application Priority Data
Sep. 13, 2024 (DE) 102024126526.4

(51) Int. Cl. F16K 11/072; F16K 27/04; F28F 27/02; B60R 16/08

(52) U.S. Cl. CPC F16K 11/072; F16K 27/045; F28F 27/02; B60R 16/08

(57) ABSTRACT

The present disclosure relates to a valve device for a fluid flow. The device includes a housing with a fluid chamber delimited by an inner surface of the housing and with at least two ports opening into the fluid chamber. A valve slide is arranged rotatably about a rotation axis in the fluid chamber. The valve slide divides the fluid chamber into at least two fluid areas and bears against the inner surface, at least in sections, to seal the fluid areas with respect to one another. An actuation mechanism is arranged at least partially in the fluid chamber for rotating the valve slide.

### TECHNCIAL FIELD

The disclosure relates to switching valves for a fluid flow and thermal management in such systems.

### BACKGROUND

Fluid flows are used to control the temperature of components. Temperature control can include heating and/or cooling. The fluid flows, which are usually liquid, serve as a heat transfer medium. By switching and/or mixing the fluid flows using a valve device, the temperature control can be controlled or regulated. For example, fluid flows with different temperatures can be mixed in order to achieve a certain temperature of the mixed fluid flow that is required for temperature control. It is also possible to switch fluid flows on or off using valve devices.

Some common valve devices may have a sluggish response, a short service life and unsatisfactory accuracy, especially with fluid flows. Furthermore, many valve devices are expensive to manufacture. There is also a desire to improve the flexibility of use for different applications.

### SUMMARY

The aforementioned task is solved by the features specified in the independent claims. Embodiments of the disclosure are given in the description, in the dependent claims and in the drawings.

A valve device for a fluid flow is described herein. For example, the valve device is arranged for switching and/or mixing one or more, for example liquid, fluid flow(s) between at least two ports, in particular three, four or more ports. In some embodiments, the valve device may include: A housing with a fluid chamber delimited/bounded by an inner surface of the housing and with at least two ports opening into the fluid chamber, a valve slide or rotary slide arranged rotatably about a rotation axis in the fluid chamber, which valve slide divides the fluid chamber into at least two fluid areas and bears against the inner surface at least in sections to seal the fluid areas to one another; and an actuation mechanism arranged at least partially in the fluid chamber for rotating the valve slide.

The valve device and/or the valve is configured in particular for switching, mixing, throttling, and/or diverting fluid flows between two or more ports. The valve device can regulate the flow of a fluid flow, in particular as a function of a rotational position of the valve slide. The valve device comprises the housing, the valve slide, and the actuation mechanism. The housing comprises the fluid chamber and at least one inner surface, that the fluid chamber is delimited by the inner surface, that the housing comprises at least two ports, that the at least two ports open into the fluid chamber, that the valve slide is arranged rotatably about a rotation axis in the fluid chamber, that the valve slide divides the fluid chamber into at least two fluid areas, that the valve slide bears against the inner surface at least in sections to seal the fluid areas with respect to one another, and/or that the actuation mechanism is arranged at least partially or completely in the fluid chamber.

In other words, for example, the proposed valve device provides a valve or switching valve for fluids or liquids, e.g., coolant, which comprises two or more connection possibilities to a mixing chamber, and/or which comprises an actuating element in the mixing chamber. The actuating element divides the mixing chamber and can be rotated by a mechanism partially or completely integrated into the mixing chamber in order to switch and/or mix between the connection options. The actuating element seals by bearing against the mixing chamber at least in certain areas, for example to reduce or avoid leakage within the mixing chamber.

The valve device is characterized by a number of technical characteristics, which can be further enhanced in particular by optional features described herein and contained in the dependent claims.

The valve device is characterized by a fast, direct, and precise and/or accurate response with a simple design. Turning the valve slide can directly influence the course of fluid flows. Due to the sealing of the valve slide on the inner surface, leakage is reduced or even avoided, so that the valve device can reliably achieve the lowest possible fluidic friction losses and/or undesirable mixing of fluid flows even at different static pressures in fluid flows or flow velocities through the fluid chamber. Because the actuation mechanism is partially or completely arranged in the fluid chamber, the valve device can be designed to be very compact. In addition, the temperature of fluid flows can be detected very directly at the actuation mechanism and/or in the fluid chamber. It is also possible to use the fluid flow itself as a lubricant for moving components of the actuation mechanism.

Furthermore, the disclosure creates variability or flexibility in that a switching behavior and/or mixing behavior or the like can be varied flexibly by adjusting the valve slide. The ports are connected to each other as a function of the rotation of the valve slide and/or whether and in what way a port is closed. The valve device can be used flexibly for splitting, throttling, mixing, switching, as a bypass and the like, in particular by variable design of the valve slide. For example, various technologies for actuation mechanisms can be implemented. The actuation mechanism can be partially accessible outside the fluid chamber in order to be able to rotate the valve slide from there, e.g., manually or motorized. Solutions controlled by a drive motor and/or a thermostat or expansion element can be implemented.

Embodiments of the disclosure may be scalable. By changing the dimensions and/or dimensions of the valve device, a performance class of the valve device can be defined or changed. For example, larger ports can be provided for larger volume flows. This reduces costs, as less effort can be required for new developments.

The valve device is intended and/or configured for a fluid flow. This means, for example, that the valve device is suitable for handling a fluid flow. The valve device can be used in connection with a fluid flow and is suitable, for example, for guiding the fluid flow, for example the valve device is designed to be fluid-tight, with the exception of the ports. The valve device can be configured as a valve, in particular a switching and/or mixing valve.

The valve device may be configured for switching a fluid flow and/or fluid flows and/or mixing fluid flows between the at least ports, for example between two, three, four or more ports. The valve device can switch between the ports. Alternatively or additionally, the valve device can mix between the ports. “Switching” a fluid flow or several fluid flows implies “switching on” and/or “switching off” and possibly “throttling” or intermediate stages thereof, i.e., “open,” ‘closed’ and possibly “half-open” or other opening positions of the valve device at one port, between two ports or between more than two ports. Switching also implies changing a fluidic connection of the ports, e.g., to redirect the fluid flow. “Mixing” of fluid flows means, for example, that two or more fluid flows are mixed together, whereby, for example, a part of one fluid flow is diverted and added to another fluid flow or whereby one fluid flow is partially or completely added to another fluid flow. Mixing can also include diverting a fluid flow.

The housing comprises a fluid chamber that may be delimited by one or more inner surfaces. The fluid chamber can guide the fluid flows. In particular, the shape of the fluid chamber is at least substantially defined by the inner surface(s). The inner surface can be understood as the inside and/or inner surface of the housing. For example, the inner surface is arranged facing away from an outer surface of the housing. The fluid chamber is, for example, a cavity into which the ports, in particular only the ports, open out.

The housing comprises the at least two ports, for example a first port and a second port, optionally a third port, optionally a fourth port, etc. A port comprises, for example, a connection option, e.g., a stub. A port may adjoins the fluid chamber and/or is fluidically connected thereto in order to direct a fluid flow into the fluid chamber and/or receive it from the fluid chamber. A port forms a transfer point for fluid flows. For example, the inner surface of each port of the at least two ports comprises an opening and/or recess. The opening may be at least substantially round. A channel leading to the opening may be provided in a port, which can be round and/or cylindrical in shape, for example.

For example, a port can be configured as male or female. A male port can accommodate a female port to provide a fluid-conducting connection that can be easily disconnectable. A port may comprise a gasket to seal in a connected state. A port may comprise a connecting element, e.g., a clamp and/or a clip, which may provide a releasable form-fitting or interlock in a connected state.

The valve slide or rotating valve slide can be moved in the fluid chamber, i.e., rotated, and/or turned about the rotation axis. The valve slide may be configured, at least in sections, as a flap. The valve slide can alternatively or additionally be configured as a plug. The valve slide may be rotatably mounted. For example, the valve slide can be rotated relative to the housing, in particular only about one axis and/or the rotation axis. For example, the valve slide is rotatably mounted on a projection and/or an axis or engages in a recess. The valve slide is to be understood as a movable component that can, for example, open or close one or more passages and/or fluid areas formed in the fluid chamber between ports.

In particular, the valve slide is arranged completely in the fluid chamber, for example in order to create as few connections to the outside as possible and possibly to increase the tightness and/or durability of the valve device. The valve slide can be driven by components separate from the valve slide, in particular the actuation mechanism and possibly a return element, for example so that no section or part of the valve slide itself needs to be arranged outside the fluid chamber in order to rotate the valve slide.

The valve slide bears against or abuts with the inner surface in order to seal in the fluid chamber and/or to divide the fluid chamber into at least two fluid areas or even three or four or more fluid areas as tightly as possible and/or without leakage. The valve slide bearing against each area, for example in point, linear or surface contact, may create a seal between the fluid areas, which may be more efficient during switching and/or mixing. A completely fluid-tight seal is not necessarily provided between the valve slide and the inner surface. It is also not necessary for the valve slide to comprise a flexible gasket and/or sealing section for sealing. It is possible that substantially hard materials, which bear against each other in areas, can adequately fulfill the proposed purpose of sealing the fluid areas, although some leakage is present. The fluid areas may provide switchable channels between the ports of the housing.

The valve slide may be provided for guiding and/or directing fluid in the fluid chamber. The valve slide may include a substantially rigid base section and/or wall section and optionally a flexible sealing section relative to the wall section, e.g., with a gasket and/or sealing lip. Furthermore, the valve slide may comprise a bearing section. The bearing section can be configured in one piece with and/or integrated into the wall section. The bearing section can be arranged between two wall sections facing away and/or facing away from each other, in particular connecting them. The bearing section serves in particular to provide the rotation axis. The bearing section may comprise a receptacle for a projection and/or for an axle. Alternatively or additionally, the bearing section may comprise a projection, e.g., a bearing pin, to be received by the housing. The bearing section can extend at least essentially parallel to the extension of the wall section. The sealing section can be provided at the edge of the wall section, in particular in sections around the respective edge of a wall section. The wall section and/or the sealing section can provide one or more end flanks of the valve slide.

In particular, the valve slide can bear against the inner surface, e.g., at least temporarily or permanently, during its movement, for example by sweeping over the inner surface during rotation. The valve slide may comprise a gasket that bears against the inner surface, for example a sealing lip.

The fluid areas can also be understood as parts of the fluid chamber that are delimited from one another, in particular in a substantially fluid-tight manner. The fluid areas may comprise a volume that is essentially the same in comparison to one another, for example differing from one another by a maximum of ±25%, a maximum of ±15%, a maximum of ±10%, a maximum of ±5% or less.

The actuation mechanism is arranged at least partially in the fluid chamber. The actuation mechanism may be provided to rotate the valve slide. For example, the actuation mechanism comprises an active and/or motorized or driving component (e.g., an expansion element, a drive motor, and/or an actuator) and/or a passive and/or rigid or non-motorized component (e.g., a lever, a cam, and/or a gear) usable for rotation.

It may be provided that the inner surface comprises one inner surface section or a plurality of inner surface sections, for example a first inner surface section and/or a second inner surface section and further possibly a third inner surface section. An inner surface section may be formed by a substantially continuous surface, for example on a particular side in the fluid chamber. The first inner surface section may be substantially round and/or cylindrical and/or concave about the rotation axis. One port, two ports, three ports, four ports or all ports of the at least two ports may extend from the first inner surface section.

The second inner surface section and the third inner surface section can face each other and/or be arranged opposite each other. For example, the second and third inner surface sections can be arranged at least substantially parallel to each other. The valve slide and/or the first inner surface section can be adjacent to the second and third inner surface sections. For example, a bottom edge of the valve slide adjoins the second inner surface section and/or a top edge of the valve slide adjoins the third inner surface section.

In some cases, at least one of the ports is arranged adjacent to and/or formed by the first inner surface section and/or extends from the first inner surface section. Two, three, four or more or all of the ports may be arranged adjacent to and/or extend from the first inner surface section. In this respect, ports can basically extend crosswise to the rotation axis from the fluid chamber and the valve slide can interact with ports on the end flank/face and/or be swept over by the valve slide on the end flank, which can, for example, be conducive to compactness and precision. These may be ports controlled by rotating the valve slide. Further ports can be freely positionable, for example arranged on the second and/or third inner surface section. It is possible that one, two, three, four or more or all of the ports are arranged adjacent to the second and/or the third inner surface section. In this respect, ports can basically extend along the rotation axis from the fluid chamber and the valve slide can interact with ports at a lateral edge and/or at the top and/or bottom.

The first and/or the second inner surface section may be provided by a first housing section of the housing. For example, the first and second inner surface sections may be provided by a single housing section. This can be favorable for low leakage and a robust housing.

The third inner surface section may be provided by a second housing section of the housing, for example in the form of a cover. The third inner surface section can alternatively or additionally be provided and/or provided by a first and/or the first housing section of a housing of an identical or like construction valve device. It is also possible that the first inner surface section may be provided proportionally by two housing sections. Multiple housing sections favor the possibilities for easy repair and maintenance. It is also possible to increase the number of variants of valve devices by adapting one of several housing sections without the need for a completely new design, which increases flexibility in an economical manner.

It may be provided that the valve slide bears against the first, the second and/or the third inner surface section at least in certain areas. An at least essentially linear contact may be provided in order to achieve the best possible seal. For example, the valve slide can bear against the second and third inner surface section and/or seal there as permanently as possible, regardless of its rotational position. For example, as a function of its rotational position, the valve slide can bear against an inner surface section in sections and/or not bear against it in sections, for example in order to cause fluid-mechanical interaction at an adjacent port and/or its opening and/or to cause leakage and/or mixing of the fluid flows. In the area of a port, the valve slide, in particular its end flank(s), may bear against it only partially or not at all so that a fluid flow can enter the fluid chamber there and/or flow out of the chamber.

The valve slide may comprise a sealing section for sealing, in particular which is formed integrally with the valve slide and/or is attached thereto. The sealing section may be or comprise a gasket. The valve slide may comprise the wall section, in particular two or more wall sections, and the sealing section. Two or more sealing sections may be provided, for example at least one sealing section per wall section. The wall section and the sealing section can be glued together and/or manufactured by means of 2K injection molding in order to be configured in one piece with each other. The wall section and the sealing section can be inserted into each other in order to be attached to each other. For example, the wall section and the sealing section can be connected to each other in a force-fitting and/or interlocking manner. The wall section may comprise a higher tensile strength and/or hardness than the sealing section. The sealing section can be configured to be flexible in order to deform when it bears against the inner surface. In particular, the sealing section comprises one or more gaskets and/or sealing lips for bearing against and/or sealing the inner surface.

It may be provided that the valve slide comprises a first wall section, a second wall section, and possibly a bearing section, in particular between the two wall sections. The two wall sections are in some cases arranged facing away from each other. The bearing section may define the rotation axis and/or coincide with the rotation axis. The bearing section can accommodate a projection and/or an axis, so that the valve slide can rotate in the fluid chamber about this projection. The bearing section may alternatively or additionally comprise a protrusion that can be received by the housing for mounting. The wall section(s), the bearing section and/or the sealing section(s) may be configured in one piece with each other and/or fixed to each other. The valve slide can thus be configured to be durable and mechanically stable and also ensure low flow resistance in the fluid chamber. It is also possible for the valve slide to rotatably move with as little effort as possible.

A wall section can comprise a receptacle for the actuation mechanism, for example in the form of an adjustment element holder. In particular, the receptacle may be provided at a distance from the bearing section and/or the rotation axis so that the valve slide can be rotated by applying force to the receptacle. A wall section can provide a sliding area, for example for mechanical interaction with the actuation mechanism, in particular with an adjustment element and/or a cam of the latter.

Furthermore, the valve slide, in particular a respective wall section, may comprise an end flank for bearing against and/or sealing the inner surface. The valve slide, in particular a respective wall section, can comprise several end flanks. An end flank can be provided by a sealing section and/or by a wall section. In particular, an end flank is set up and/or configured to enter into fluidic interaction/interaction with an inner surface and/or a port and/or its opening, in particular to effect switching and/or mixing. In particular, an end flank can bear against and/or not bear against the inner surface and/or seal and/or not seal against the inner surface as a function of a rotational position of the valve slide.

The valve slide can comprise at least one first end flank, which may be at least substantially linearly adjacent to or in line contact with and/or can bear against the inner surface, possibly the first inner surface section, the second inner surface section and/or the third inner surface section. A first end flank can form a free end and/or an edge or an edge of a valve slide. A first end flank may be configured to be elongated and/or linear and/or rectilinear at least in sections; optionally, it can be curved and/or kinked, in particular shaped to correspond to the adjacent inner surface section. The first wall section, the second wall section or both wall sections and/or respective sealing sections may comprise one of the at least one first end flank and/or one first end flank or several thereof. For example, a first end flank can form an edge of a wall section and/or sealing section. Several end flanks or several sections of a first end flank can be directly adjacent to one another and/or arranged parallel, obliquely or at right angles to one another.

It may be provided that the valve slide comprises at least a second end flank. A second end flank can at least substantially flatly adjoin and/or bear against the inner surface, for example against the first inner surface section and/or another inner surface section, and/or extend at least substantially in the circumferential direction and/or around the rotation axis in sections. A second end flank may extend at least essentially over a flat area, sometimes spatially. A second end flank can partially or completely cover an opening of a port, for example as a function of a rotational position of the valve slide. A second end flank can be formed by a wall section and/or is may be configured to be convex on the side facing the inner surface. At a free end, a second end flank comprises, for example, an edge, possibly an edge running in a straight line at least in sections. The edge can be oriented at least essentially parallel to the rotation axis.

The first wall section, the second wall section or both wall sections and/or respective sealing sections may comprise or form a second end flank and/or a first end flank or several thereof. Two second end flanks can point at least substantially in the same direction or in opposite directions in the circumferential direction. One or more second end flank(s) can be used to reduce or prevent backflow. It is also possible to use the second end flank, for example when cold-starting a vehicle, to keep a circuit and/or a bypass temporarily closed in order to achieve the fastest possible temperature control.

It may be provided that the at least one second end flank, in particular its edge, which extends in a straight line at least in sections, comprises a recess extending in the circumferential direction around the rotation axis and/or is V-shaped. For example, the second end flank may comprise a notch and/or a slot as the recess. The recess makes it possible to set a defined variable flow cross-section between the fluid chamber and the port as a function of a rotational position of the valve slide. Normally, i.e. e.g. with a straight edge, the flow cross-section is primarily dependent on the shape of the opening of the port, which is regularly round; now the recess creates further design freedom for adjusting the function of the valve device when the valve slide is rotated, as the shape of the port does not necessarily have to be varied for this purpose and/or can remain in a shape that is suitable for production or cost-effective. The recess can enable ports to be opened or closed as smoothly as possible with regard to the fluid flow(s).

The recess can alternatively or additionally be provided on a first end flank, for example, whereby this recess extends radially and/or crosswise to the circumferential direction and/or along a wall section; for example, a permanent leakage between fluid areas can thus be achieved.

It may be provided that the housing comprises at least one stop against which the valve slide can abut/stop, in particular the first and/or second end flank, possibly in order to define a first rotational position of the valve slide. The stop can define an initial position of the valve slide in the fluid chamber. The stop can extend along a respective end flank, for example to enable at least substantial sealing. It is also possible for the stop to be configured so that leakage can flow between the stop and the end flank. Leakage is intended, for example, to ensure that fluid is exchanged in the fluid chamber and/or between fluid areas, for example to circulate the actuation mechanism at a controlled temperature and/or to avoid deposits. The stop can be configured as a radial projection in the fluid chamber. The stop is possibly located on the first inner surface section. Several stops can be provided, for example one stop per end flank.

It may be provided that the at least two ports open into the fluid chamber, in particular at a distance from one another in the circumferential direction around the rotation axis. An angle between two adjacent ports in the circumferential direction around the rotation axis can be at least 10 degrees and up to 170 degrees. The angle is measured from the center of an opening of a port. If ports are opposite each other on a round fluid chamber with a central rotation axis, the angle is 180 degrees. The angle may be between 10 and 170 degrees to obtain a compact valve device. If there are more than two ports, an angle between adjacent ports of may be between 10 and 130 degrees. For example, the angle is 90 ± 25 degrees.

It may be provided that a first port and a second port of the at least two ports, alternatively or optionally further ports, are arranged at least substantially parallel to each other and/or facing away from each other. For example, two of the ports may point in opposite directions and/or be arranged facing away from each other. This can enable compact connection in practice, for example by incorporating the valve device into a line without changing the basic direction of the line. This can reduce manufacturing costs. In particular, demoldability can be facilitated when manufacturing the housing with the ports by means of injection molding if several ports are arranged at least essentially in parallel.

It may be provided that one of the ports is configured to correspond to another of the ports. In particular, two of the ports correspond mechanically so that several of the valve devices can be connected and/or cascaded. For example, a first port can be configured to correspond to a second port, in particular in order to connect two identical valve devices fluidically and mechanically by means of a first and a second port of the two identical valve devices. For example, the first port can correspond mechanically to the second port in that it can be plugged into the second port.

Valve devices can be configured to be stackable, in particular along the rotation axis. One/the first housing section of the housing can be configured to correspond mechanically to one/the second housing section of the housing facing away from the fluid chamber, possibly in order to stack two identical valve devices with coaxially arranged rotation axes in an interlocking manner. This means that several valve devices can be stacked, with the housing sections forming an interlock crosswise to the rotation axis, so that stable stackability is achieved. For example, the outside of the second housing section can at least partially accommodate the outside of the first housing section, or vice versa. Alternatively or additionally, it is possible for two identical first housing sections to form and/or close at least one fluid chamber between each other. In particular, an outer side of one of the two first housing sections can substitute a second housing section and/or form a cover. This allows the number of components to be reduced.

The housing, in particular the first housing section, can comprise one or more mounting elements, for example a screw holder and/or a projection for mounting. The projection for mounting can comprise the screw holder. For example, the screw holder can extend along and/or parallel to the rotation axis, in particular to enable stacked valve devices to be screwed together or to enable valve devices to be attached to a vehicle.

It may be provided that a third and a fourth port of the at least two ports are arranged pointing at least essentially in the same direction and/or crosswise to the first and/or second port. For example, two of the ports point in the same direction to enable compact line routing. This can reduce manufacturing costs and demoldability.

It may be provided that the actuation mechanism is configured to rotate the valve slide, in particular steplessly, for example to rotate from a/first rotational position in the direction of a second rotational position. The second rotational position is to be understood, for example, as the end position. The rotational positions are spaced apart, for example, by an angle of at least 5 degrees and/or at most 55 degrees, possibly by an angle of 30 degrees ± 15 degrees. The valve slide can be rotated at least between the first and second rotational positions.

The actuation mechanism may comprise an adjustment element. The adjustment element can bear against the valve slide away from and/or at a distance from the rotation axis and/or be mounted against the housing. For example, the adjustment element can apply a force to the valve slide, allowing the valve slide to be rotated. The adjustment element can engage in the adjustment element holder of the valve slide and/or slide against the slide-off or sliding area of the valve slide. The adjustment element can also be supported against and/or on an adjustment element holder of the housing, for example rotatably.

The adjustment element can be configured to rotate the valve slide as a function of a rotation of the adjustment element. For example, the adjustment element may comprise a cam that deflects the valve slide when it is rotated. The adjustment element and/or the cam can bear against or slide against the sliding area of the valve slide. The cam can be configured to strike against an adjustment element stop of the housing, in particular away from the sliding area, in order to be able to reference the rotational position of the cam.

The adjustment element can be configured to rotate the valve slide as a function of an ambient temperature and/or temperature. The adjustment element may comprise an expansion element. For example, the expansion element can be arranged in the fluid chamber in order to be able to expand and/or contract as a function of the temperature of the fluid flow. The expansion element may regularly require a certain leakage, in particular when the valve slide is in the first rotational position. The expansion element can be held in a holder of the adjustment element. The holder can be accommodated in and/or on the adjustment element holder of the housing, in particular rotatably. The expansion element can also engage in the adjustment element holder of the valve slide.

It may be provided that the actuation mechanism comprises a return element arranged in the fluid chamber. The return element can be configured to return the valve slide, in particular in the direction from the second to the first rotational position. The return element can be formed by a spring, in particular a spiral spring and/or torsion spring. The return element can be configured from a polymer compound and/or plastic and/or metal and/or metallic. The return element can comprise a very elastic material, for example an elastomer and/or a rubber. The return element can be arranged radially spaced from the rotation axis to act on the valve slide. For example, the return element can be arranged opposite and/or in the opposite direction to the adjustment element to act on the valve slide. The return element can be placed on a projection of the fluid chamber, with the projection being arranged at a distance from the rotation axis, for example, and in particular parallel to the rotation axis. The return element can act between a counter bearing of the housing and the valve slide. The counter bearing can be a projection of the housing, for example on the first inner surface section. The return element can cause the valve slide to return to the first rotational position as automatically as possible. This allows the adjustment element, if provided, to be configured in a simplified manner.

It may be provided that the actuation mechanism comprises a drive motor arranged outside the fluid chamber, possibly which is non-rotatably connected to the adjustment element for rotating the adjustment element. The drive motor may comprise a gearbox, in particular a reduction gearbox, to provide a controllable low speed and/or rotational position. The drive motor can receive and implement a control command and/or positioning command to rotate the valve slide, in particular to rotate the valve slide by a certain angle and/or as a function of a temperature. The drive motor can optionally provide a signal about the position of the valve slide. The drive motor can optionally reference the adjustment element with regard to its rotational position, for example by moving it against a stop. The adjustment element and/or a shaft section of the adjustment element can be guided fluid-tightly and rotatably through a passage of the housing. A/the second housing section of the housing can provide the passage. The passage can be a bore and/or a hole in the housing. For example, the passage may comprise a seal holder for a ring seal and/or a shaft seal. In this way, the drive motor can be kept away from electrically conductive fluid flow and still be used to actuate the adjustment element, particularly directly.

It may be provided that the housing and/or the valve slide comprise or are formed at least in part from a polymer compound and/or plastic and/or a metal material and/or a metal alloy. For example, plastics can be easily manufactured by means of plastic injection molding. Metal materials can create valve devices that are as wear-resistant and durable as possible.

A thermal management system for an electrified/electric vehicle is also proposed. The vehicle may comprise a drive train that is at least partially configured to drive the vehicle electrically. For example, the vehicle and/or the thermal management system may comprise or be thermally linked to a traction battery, an electric drive motor or traction motor, a passenger cabin, control electronics or electronics, a fuel cell, an internal combustion engine and/or the like, which may or may not be temperature controlled. The vehicle can be partially or fully electrified. For example, a hybrid vehicle with an internal combustion engine and an electric drive motor in the drive train is partially electrified. For example, a vehicle with only electric motors and/or electric drive motors in the drivetrain is fully electrified.

The thermal management system may comprise a/the valve device, a heat source and/or sink, and in particular a pump for providing a fluid flow. The valve device may be configured to supply the heat source and/or sink with the fluid flow as a function of a temperature of the fluid flow. Several valve devices and/or several heat sources and/or heat sinks may be provided. For example, the valve device can be integrated into an oil circuit or a water circuit in order to switch and/or mix oil and/or water as fluid flow(s). The valve device is suitable, for example, for being integrated into a battery circuit and/or a fuel cell circuit of the vehicle.

For example, the valve device can be used with four ports, in particular as a 4-port 2-way valve and/or as a 4/2 valve. In a thermal management system, the valve device can be used to loop or integrate a heat exchanger into a cooling circuit as a heat source and/or sink depending on the temperature, in particular successively as a function of the temperature. Alternatively or additionally, a fluid circuit can be switched and/or mixed to another fluid flow, in particular to a colder or warmer fluid flow, for temperature control by means of the valve device in the case of a traction battery to be temperature-controlled or in the case of switching electronics to be temperature-controlled, which can each be regarded as a heat source and/or sink.

Further, a use of a/the valve device in an/the electrified vehicle is proposed, in particular for switching and/or mixing a fluid flow in the vehicle. The valve device may be part of a/the thermal management system. The fluid flow may comprise a liquid and/or be liquid.

Furthermore, a method is proposed for switching and/or mixing a fluid flow, in particular a liquid fluid flow, or a plurality of fluid flows between at least two ports of a/the valve device. The valve slide can be rotated as a function of a temperature of a fluid flow and/or as a function of a control command and/or positioning command.

In the context of the disclosure, the abbreviation ”or” is a short form for “respectively” and is basically intended to indicate alternative, basically equivalent, and/or synonymous features or terms in order to bring the idea and/or meaning of a feature or term usage closer. “Respectively” and “or” can always be replaced with “and/or.”

### BRIEF DESCRIPTION OF THE DRAWINGS

In the following, the disclosure is explained in further detail with reference to the drawings by means of preferred embodiments. The drawings show

FIG. 1 a perspective view of a first housing section of a valve device,

FIGS. 2A-B a valve device with an expansion element in perspective views, shown once without the second housing section (2A) and once with the second housing section (2B),

FIGS. 3A-B a valve device with a cam in perspective views, shown once without a second housing section (3A) and once with a second housing section (3B),

FIG. 4 a valve slide for a valve device and with first end flanks in perspective view,

FIG. 5 a valve slide for a valve device and with second end flanks in perspective view,

FIG. 6A-B a valve device with NW20 ports (6A) and a valve device with NW32 ports (6B) in a plan view,

FIG. 7A-B a valve device with the valve slide from FIG. 4 in various rotational positions (7A) and a valve device with the valve slide from FIG. 5 in various rotational positions (7B) in a plan view,

FIGS. 8A-B a valve device with the valve slide from FIG. 4 in various rotational positions (8A) and a valve device with the valve slide from FIG. 5 in various rotational positions (8B) in a plan view,

FIGS. 9A-C cascaded valve devices in perspective views, and

FIGS. 10A-B schematic views of circuit diagrams with a thermal management system of an electrified vehicle.

### DETAILED DESCRIPTION

Where the same reference signs are used in the figures, the following description applies accordingly to the figures themselves. Examples are described which can be modified and/or supplemented in various ways within the scope of the claims and the description. Each feature described for a particular example can be used independently or in combination with other features in any other example. Any feature described for an example of a particular claim category may also be used in a corresponding manner in an embodiment example, for example of another claim category and/or another aspect of the disclosure.

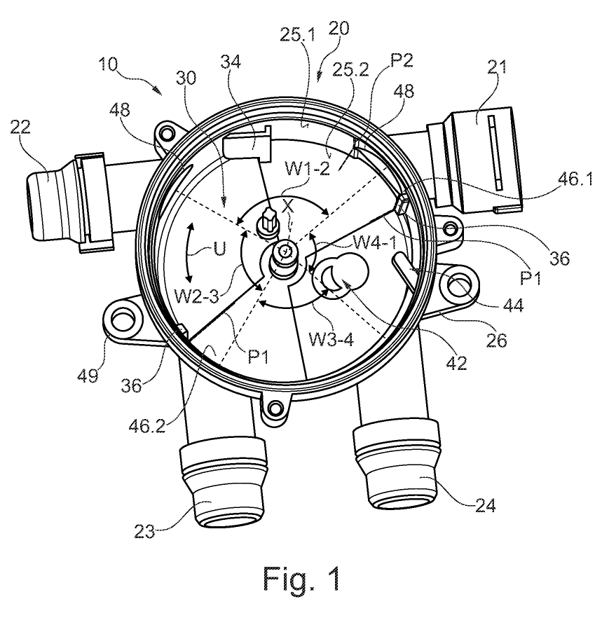

FIGS. 1 to 3 and 6 to 9 each show a valve device 10 for fluid flows, more precisely for switching and/or mixing fluid flows between at least two, namely between four, ports 21, 22, 23, 24. The valve device 10 comprises a housing 20 with a fluid chamber 30 delimited by an inner surface 25 of the housing 20, wherein the ports 21, 22, 23, 24 open into the fluid chamber 30. Openings 48 of the ports 21, 22, 23, 24 open into the fluid chamber 30.

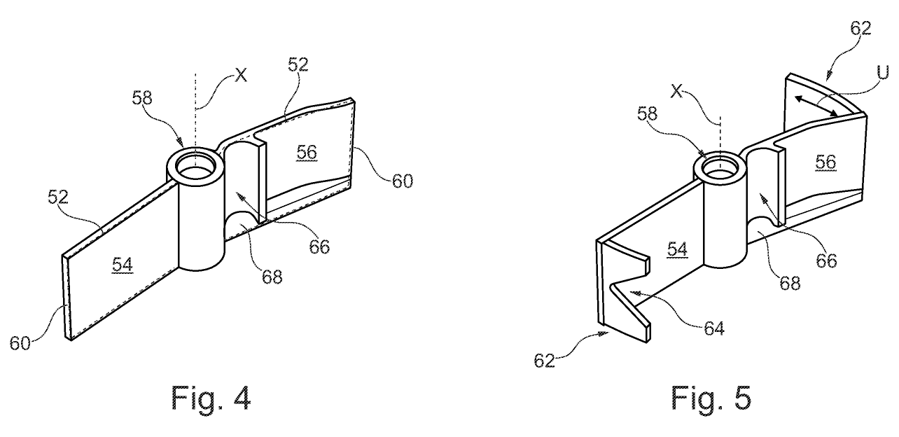

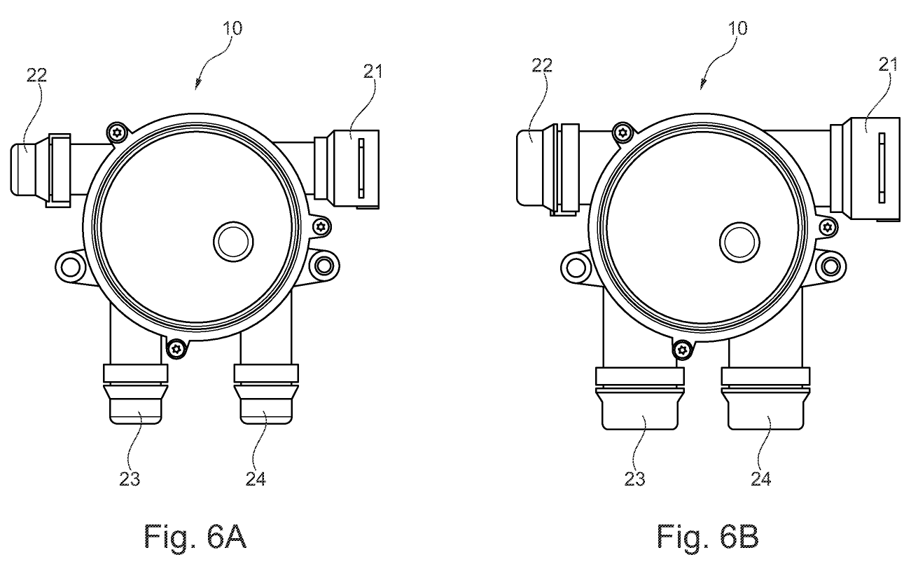

The valve device 10 comprises a valve slide 50 to be arranged rotatably about a rotation axis X in the fluid chamber 30, which is not shown in more detail in FIG. 1. Various valve slides 50 are shown in FIGS. 4 and 5.

A valve slide 50 to be arranged in the fluid chamber 30 can rotate in an optionally provided valve slide receptacle 46.1, 46.2, which is adapted to the shape of the valve slide 50. For example, the valve slide receptacle 46.1, 46.2 is provided in a recess in the Housing 20, possibly defining at least one rotational position P1 and optionally a second rotational position P2 of the valve slide 50 at its edges.

In particular, the Housing 20 comprises two opposite stops 36 in the fluid chamber 30 for stopping a valve slide 50. The stops 36 and/or the valve slide receptacle(s) 46.1, 46.2 define the first rotational position P1 of the valve slide 50. It is possible that more than two, only one or no stop 36 is provided.

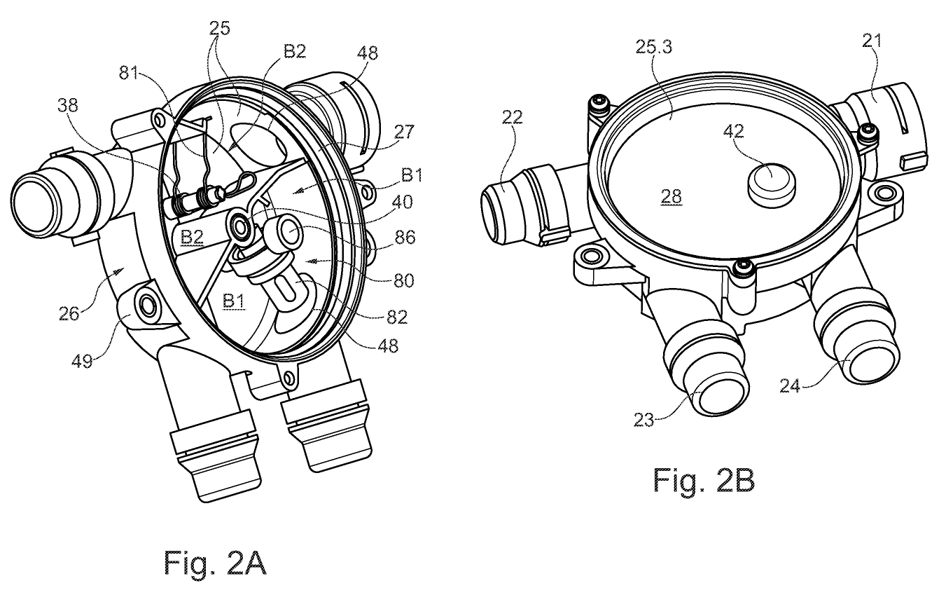

The valve slide 50 to be arranged in the fluid chamber 30 divides the fluid chamber 30 into two fluid areas B1, B2 and bears against the inner surface 25 at least in sections to seal the two fluid areas B1, B2 with respect to each other, see for example FIGS. 2A, 3A, 7A-B or 8A-B. During its rotation about the rotation axis X, the valve slide 50 can slide along the inner surface 25 in a sealing manner at least in some areas and/or lift off from it (as for example in the valve slide receptacle 46.1) and interact with the openings 48 in order to influence fluid flows and/or to cause switching and/or mixing.

The inner surface 25 is essentially round and cylindrical around the rotation axis X in a first inner surface section 25.1. The four ports 21, 22, 23, 24 extend from the first inner surface section 25.1 via their openings 48. The four ports 21, 22, 23, 24 open into the fluid chamber 30 at a distance from one another in the circumferential direction U around the rotation axis X. An angle W1-2, W2-3, W3-4, W4-1 between two ports 21, 22, 23, 24 adjacent in the circumferential direction U about the rotation axis X is between 10 degrees and 170 degrees, for example 90 degrees ± 25 degrees. The angles W1-2, W2-3, W3-4, W4-1 amount to a total of 360 degrees.

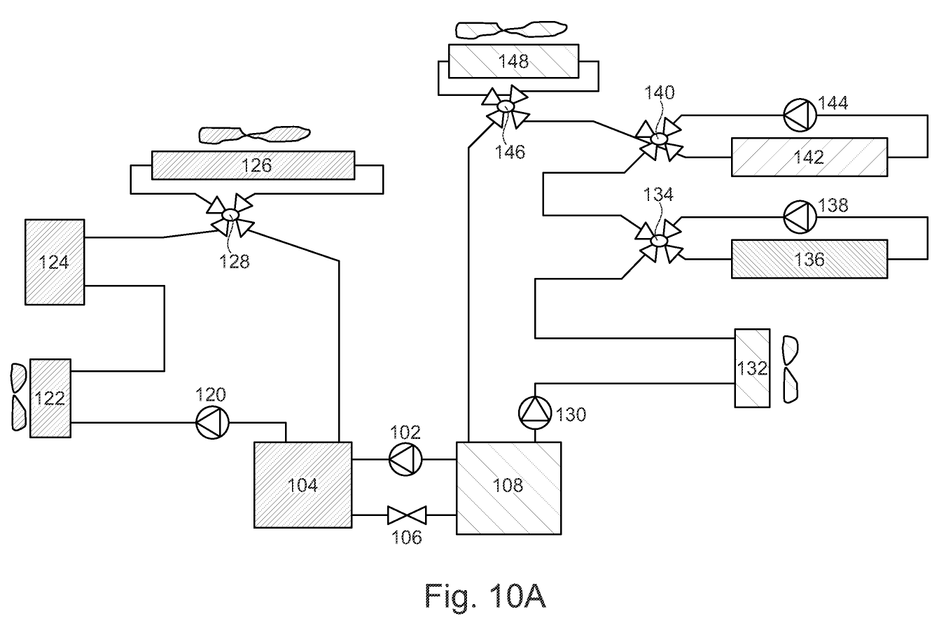

With reference to FIGS. 1 and 9A-C, a first 21 and a second 22 of the four ports 21, 22, 23, 24 are arranged parallel to each other and facing away from each other. The first port 21 is configured to correspond to the second port 22 in order to fluidically and mechanically connect two identical valve devices 10, 10' by means of a first 21, 21' and a second 22, 22' port of the two identical valve devices 10, 10', for example in order to obtain a series connection, see FIG. 9A. In particular, the first port 21, 21' is configured as female and the second port 22, 22' as male. In the present case, the second port 22 comprises a connecting element, for example a clamp, for releasably fixing connected ports 21', 22 to one another by means of an interlock. The connecting element engages in an interlocking manner in a recess of the first port 21', see FIG. 9A. The connecting element can, for example, automatically engage when ports 21', 22 are inserted into each other.

A third 23 and a fourth 24 port of the four ports 21, 22, 23, 24 point in the same direction and are also arranged crosswise to the first 21 and the second 22 port. The ports 23 and 24 are arranged in parallel. A first housing section 26 of the housing 20 facing away from the fluid chamber 30 is configured mechanically corresponding to a second housing section 28 of the housing 20 in order to stack two identical valve devices 10, 10' with parallel and in particular aligned and/or coaxially arranged rotation axes X in an interlocking manner, see FIGS. 9B-C. Several, in particular stacked, valve devices 10, 10' can be connected to each other, for example screwed together, for example via mounting elements 49, 49', see FIG. 9B. It is also possible to connect several and/or stacked valve devices 10, 10' via connecting pieces, see FIG. 9C.

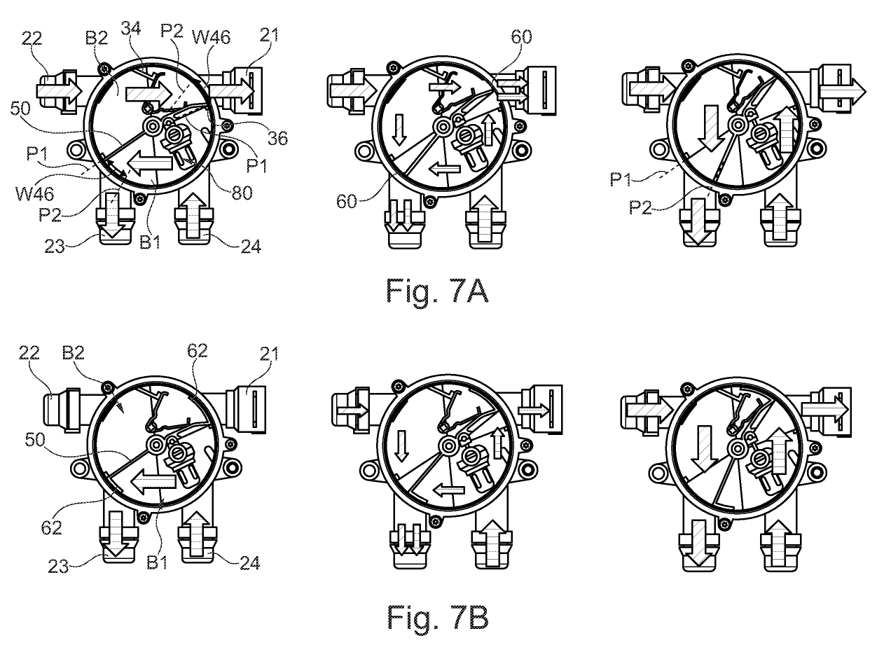

In FIG. 1, a second inner surface section 25.2 can be seen, which basically forms a bottom of the fluid chamber 30. The inner surface sections 25.2 and 25.3 are provided by a first housing section 26 of the housing 20. A third inner surface section 25.3, which is not shown in FIG. 1 and which in FIG. 2B and in FIGS. 6A-B faces the closed fluid chamber 30 and/or the second inner surface section 25.2, may be provided by a second housing section 28, which is connectable to a first housing section 26. In order to detachably seal the housing sections 26, 28 against each other, a gasket 27 can be arranged between the first housing section 26 and the second housing section 28, for example an annular gasket. The gasket 27 can be received by the first housing section 26.

The second housing section 28 can be configured as a cover for the first housing section 26. The second housing section 28 can be connected to the first housing section 26, in particular in a detachable manner, for example by screwing, as in the present case.

Alternatively or additionally, the third inner surface section 25.3 can be provided by a further first housing section of a housing of an identical valve device.

The inner surface sections 25.2 and 25.3 regularly face each other, are arranged substantially parallel to each other and can adjoin the valve slide 50 on the upper and/or lower side (i.e., on the edge along the rotation axis X). Further, the inner surface sections 25.2 and 25.3 are adjacent to the first inner surface section 25.1 to define the fluid chamber 30.

With reference to FIGS. 2A-B and 3A-B, it can be seen, for example, that the valve slide 50 can bear against a first 25.1, a second 25.2 and, in particular when the second housing section 28 is in contact, a third 25.3 inner surface section in order to seal there against. The valve slide 50 may comprise a sealing section 52 which is formed integrally with the valve slide 50 (e.g., molded or bonded thereto) and/or attached thereto (e.g., mounted in an interlocking manner). The valve slide 50, in particular the sealing section 52, can bear against the housing 20 and/or the valve slide receptacle 46.1, 46.2 in certain areas and in particular as a function of the rotational position of the valve slide 50.

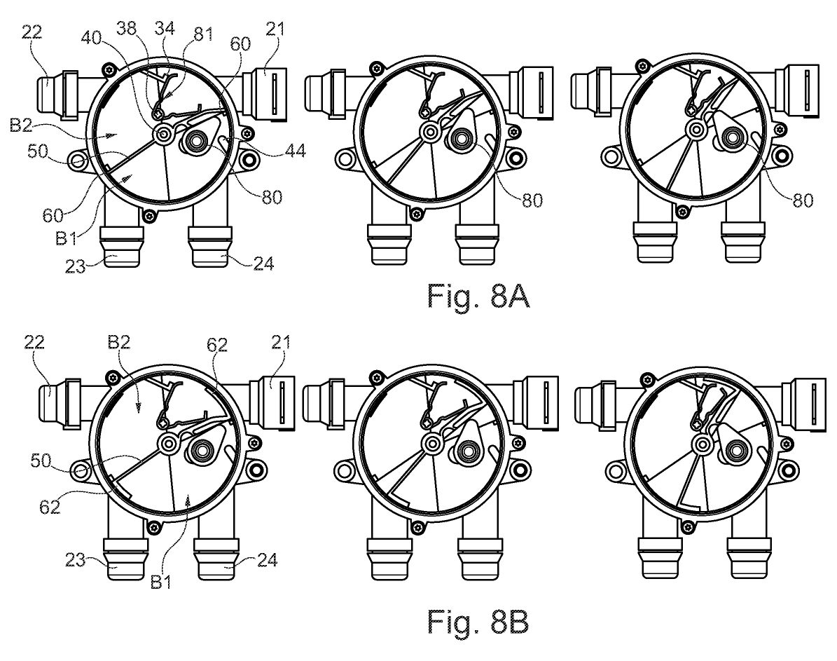

In particular, the valve slide receptacle provided with reference sign 46.1 extends in some areas over the first inner surface section 25.1, in particular over the opening 48 of the first port 21, see FIGS. 1 or 7A. The valve slide receptacle 46.1 is in some areas, in particular between rotational positions P1 and P2 of the valve slide 50, radially recessed relative to the rotation axis X in order to reduce friction of the valve slide 50 in the area of the first port 21 and/or so that the valve slide 50 is spaced there from the inner surface section 25.1. This can also be provided analogously at their ports 22, 23, 24, for example at the third port 23.

For example, the valve slide receptacle provided with reference sign 46.2 extends in some areas over the second inner surface section 25.2, see FIG. 1. The valve slide receptacle 46.2 can also be provided analogously on the third inner surface section 25.3, i.e., opposite along the rotation axis X.

The valve slide 50 may bear against one or both valve slide receptacle(s) 46.1, 46.2 in the housing 20 and/or the inner surface 25 in at least one rotational position, for example in the rotational position P1, in order to achieve a seal between the fluid areas B1, B2. The valve slide 50 can bear against the inner surface 25 in a linear and/or planar manner for sealing at one or more sections of the valve slide 50. It is provided in the present case that the valve slide 50 lifts off the valve slide receptacle 46.1 by up to 2 mm when it is deflected from the first rotational position P1.

With reference to FIGS. 4 and 5, valve slides 50 are shown which comprise a first wall section 54, a second wall section 56, a bearing section 58 between the two wall sections 54, 56, and possibly a sealing section 52. The valve slides 50 are configured as a flap and/or adjusting flap. The valve slides 50 are injection-molded plastic parts. In FIG. 4, the sealing section 52 is shown dashed on a valve slide 50. The sealing section 52 is arranged at the edge of the valve slide 50. The two wall sections 54, 56 on a valve slide 50 face away from each other. The bearing section 58 comprises a receptacle for a projection 40 of the housing 20. The receptacle is, for example, essentially round and/or cylindrical and/or configured as a bore and defines the rotation axis X or coincides therewith. The bearing section 58 can be placed on the projection 40 and/or dome and can be rotatably supported by it, see also FIG. 2A.

The valve slide 50 of FIG. 4 comprises at least one first end flank 60, which can at least substantially linearly adjoin and/or bear against the first inner surface section 25.1. Both wall sections 54, 56 comprise one of the at least one first end flank 60. The first end flanks 60 are arranged opposite each other. The first end flanks 60 are further configured to seal by means of the sealing section 52. The first end flanks 60 run parallel to the rotation axis X.

The valve slide of FIG. 5 comprises two second end flanks 62, which can adjoin the correspondingly concave first inner surface section 25.1 at least substantially flat on one convex side and extend in the circumferential direction U. Both wall sections 54, 56 comprise one of the two second end flanks 62, wherein the two second end flanks 62 in particular point in the same direction in the circumferential direction U, for example in order to avoid a backflow into the openings 48 and/or to reduce jerking movements in fluid flows. A second end flank 62 can partially or completely cover an opening 48. The first 60 or the second 62 end flank can abut against a respective stop 36 of the housing 20 and, in particular, seal thereagainst. In an abutted rotational position of a valve slide 50, the first rotational position P1 is defined, see also FIGS. 2A and 3A and 7A and 7B on the left. The first rotational position P1 can be understood as an initial position.

It can be seen in FIG. 5 that one of the second end flanks 62 comprises, at its free end and/or its edge, a recess 64 extending in the circumferential direction U around the rotation axis X and also V-shaped in the present case. This recess 64 is used for the targeted adjustment of a flow cross-section at an adjacent opening 48 as a function of a rotational position of the valve slide 50, for example in order to be able to throttle a flow successively and as a function of the rotational position of the valve slide 50. This can create independence from the shape of the opening 48, which is regularly, usually due to the manufacturing process, round and/or round-shaped 48. The second end flank 60 and/or the recess 64 further serve(s) to control and/or reduce a bypass flow and can be adapted to a pressure loss and/or flow resistance of a heat exchanger in order to maintain a continuous flow through it. In particular, the second end flank 62 and/or recess 64 may enable soft-opening and/or soft-closing to reduce pressure surges in the fluid.

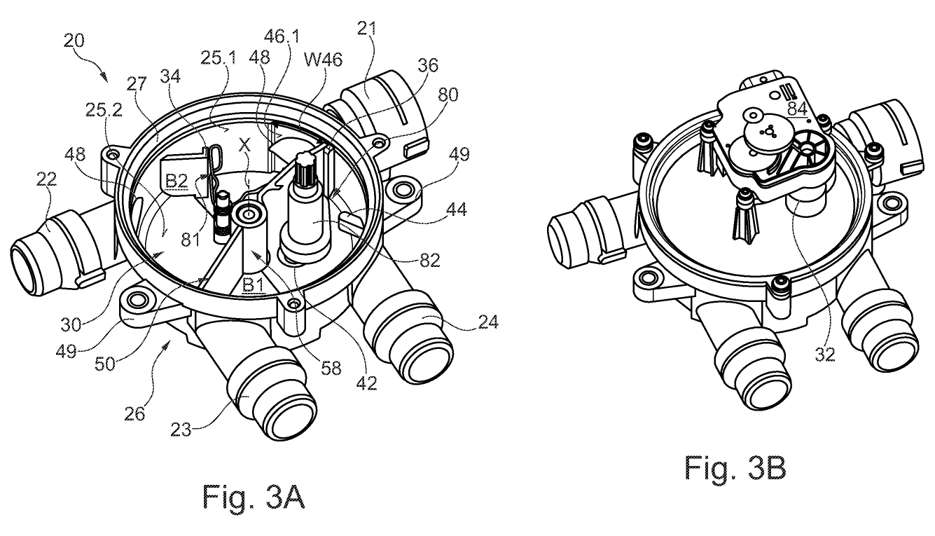

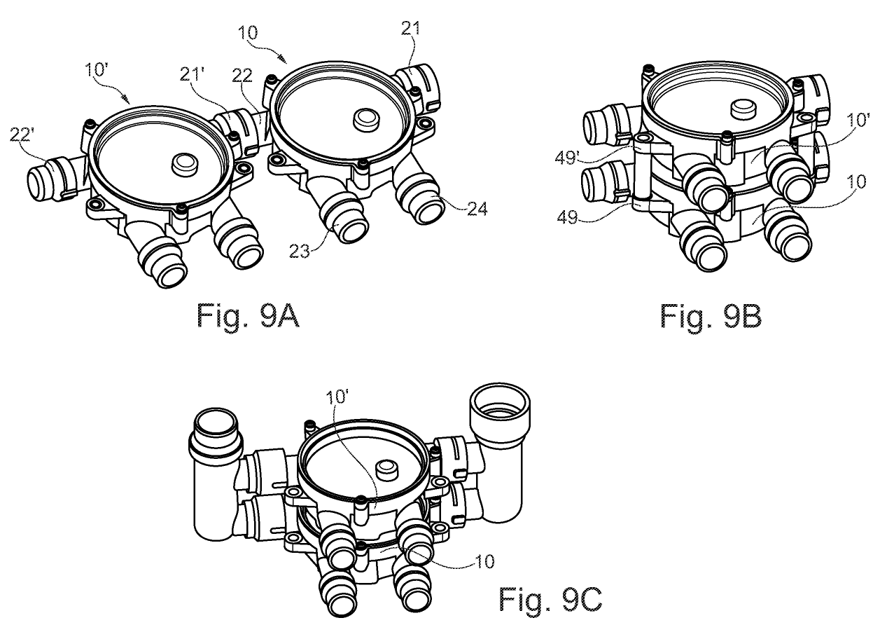

The valve device 10 comprises an actuation mechanism 80 arranged at least partially in the fluid chamber 30 for rotating the valve slide 50, which is not shown in more detail in FIG. 1. Actuation mechanisms 80 that can be incorporated into the housing 20 shown in FIG. 1 are shown, for example, in FIGS. 2, 3, 6, 7, 8 and 9. One actuation mechanism 80 is arranged completely in the fluid chamber 30 and comprises, for example, a wax-based expansion element, cf. FIGS. 2, 6, 7, and 9. Another actuation mechanism 80 is arranged partially in the fluid chamber 30 and comprises a rotatably movable cam, cf. FIGS. 3 and 8.

The valve slides 50 of FIGS. 4 and 5 each comprise an adjustment element holder 66 and a sliding area 68. The adjustment element holder 66 is, for example, a recess which is arranged at a distance from the rotation axis X, for example arranged next to the rotation axis X. The sliding area 68 is, for example, a reinforced and/or continuous and/or rectilinear flank, which possibly extends along a/the wall section 56 and/or crosswise and/or perpendicular to the rotation axis X. The valve slides 50 and, in particular, the first housing sections 26 can each be used with the various actuation mechanisms 80 described herein.

It is also conceivable that a valve device and/or its valve slide can be both motor-driven and driven by means of an expansion element (not shown in detail) in order to achieve redundant operation. This can increase reliability. In addition, the functionality can be extended.

The two actuation mechanisms 80 shown in FIGS. 2A-B and 3A-B are configured to rotate the valve slide 50 starting from the first rotational position P1 towards a second rotational position P2. The second rotational position P2 is achieved in the present case by rotating the respective valve slide 50 counterclockwise in the respective view, in particular by less than 90 degrees. The second rotational position P2 corresponds, for example, to the maximum deflection of the valve slide 50 away from the first rotational position P1 by the actuation mechanism 80. Between the first P1 and second P2 rotational positions, there is an angle of movement W46 of the valve slide 50 which, by way of example, is at least 1 degree and up to 55 degrees, in particular 30 degrees ± 10 degrees.

An adjustment element 82, which bears against the valve slide 50 away from the rotation axis X and is supported against the housing 20, is provided for rotating the valve slide 50. A return element 81 arranged in the fluid chamber 30 is provided in the present case for resetting the valve slide 50, specifically in the direction from the second P2 to the first P1 rotational position. The return element 81 is formed by a metallic spring, in particular a torsion spring. The return element 81 is arranged radially spaced from the rotation axis X for acting on the valve slide 50. The return element 81 is placed on a projection 38 and/or dome of the housing 20. The projection 38 extends parallel to the rotation axis X and is radially spaced therefrom. The return element 81 is mounted on a counter bearing 34 of the housing 20.

In particular, in a plan view along the rotation axis X, the counter bearing 34, the projection 38 for a/the return element 81 and the projection 40 for a/the valve slide 50 form a triangle in order to obtain a comparatively large angle of rotation for the valve slide 50.

In FIGS. 2A-B, the adjustment element 82 comprises an expansion element and an adjustment element holder 86, wherein the adjustment element holder 86 pivotably supports the expansion element in the housing, in particular pivotably parallel to the rotation axis X. The adjustment element 82 is configured to rotate the valve slide 50 as a function of a temperature, for example an ambient temperature and/or a temperature of a fluid flow. The adjustment element 82 can expand with increasing temperature and thus act on the valve slide 50. In the present case, the expansion element faces the opening 48 and/or the port 24 and can thus be directly exposed to the flow.

The adjustment element holder 86 may be received by the adjustment element holder 42 of the housing 20, for example a recess or a projection, in particular rotatably.

The adjustment element holder 42 can be provided in the first housing section 26 and an adjustment element holder 42 can be provided in the second housing section 28, for example in order to obtain two opposing adjustment element holders 42 between which an adjustment element holder 86 can be received interlockingly and/or rotatably, as is the case, for example, in FIGS. 2A-B.

The adjustment element holder 42 can be provided in the first housing section 26, for example to accommodate a cam in an interlocking manner and/or rotatably, as is the case, for example, in FIGS. 3A-B. The cam may further protrude through the second housing section 28, for example to be rotatably held by the second housing section 28.

The adjustment element holder 42 shown is suitable for both a cam and an adjustment element holder 86, so that the housing 20 is suitably configured for various actuation mechanisms 80.

In FIGS. 3A-B, the adjustment element 82 comprises a cam. The adjustment element 82 is configured to rotate the valve slide 50 as a function of a rotation of the adjustment element 82. The cam can slide on the sliding area 68 of the valve slide 50 in order to rotate the valve slide 50. An adjustment element stop 44 of the housing 20 can enable referencing and/or calibration travel of the cam.

With reference to FIG. 3B, the actuation mechanism 80 comprises an electric drive motor 84 arranged outside the fluid chamber 30, which is non-rotatably connected to the adjustment element 82 for rotating the adjustment element 82. The adjustment element 82 is fluid-tight and rotatably guided through a passage 32 of the housing 20. The second housing section 28 provides the passage 32. The drive motor 84 is also fixed, for example screwed, to the second housing section 28. The drive motor 84 can rotate and/or actuate the cam parallel to the rotation axis X.

The housing 20 and the valve slide 50 are each possibly made of plastic and may be injection-molded parts. It is conceivable to use a metal alloy.

With reference to FIGS. 6A-B, two valve devices 10 are shown which comprise ports 21, 22, 23, 24 of different sizes. The ports 21, 22, 23, 24 each comprise stubs. A flow cross-section of one stub, several stubs or in particular all stubs or ports 21, 22, 23, 24 is for example approx. 310 mm ² ± 20 % (cf. FIG. 6A) or 575 mm²± 20 % (cf. FIG. 6B). One stub, several stubs or in particular all stubs comprise a nominal width of 20 mm and/or NW20 (cf. FIG. 6A) or 32 mm and/or NW32 (cf. FIG. 6B) or another nominal width. For example, the ports 21, 22, 23, 24 can be configured in such a way that the valve device 10 is VDA-compliant. For example, the valve devices 10 shown in FIG. 6 with four ports 21, 22, 23, 24 and two paths for fluid flows can be designated as “4/2 VDA NW20” (cf. FIG. 6A) or “4/2 VDA NW32” (cf. FIG. 6B), which is understood in specialist circles in the automotive industry and/or vehicle technology.

With reference to FIGS. 7A-B, the mode of operation of a valve device 10 with an expansion element and with the valve slide 50 of FIGS. 4 and/or 5 is to be explained. The valve slide 50 is rotated as a function of the temperature of the fluid entering the port 24, for example, which hits the expansion element in the present case. As the temperature rises or falls, the expansion element can lengthen and automatically rotate the valve slide 50 counterclockwise. If the temperature falls and/or rises in the opposite direction, the return element 81 can rotate the valve slide 50 in the opposite direction.

In FIGS. 7A-B and 8A-B, several arrows are drawn to indicate fluid flow information. A size of an arrow indicates a size of a volumetric flow; for example, when a fluid flow is divided, the volumetric flow becomes smaller in some areas, and one large arrow may become two smaller arrows in different areas. The direction of an arrow indicates the direction of the fluid flow. The hatching of an arrow indicates the temperature of the fluid flow; for example, a horizontal hatching means “warm” and an oblique hatching means “cold.” Mixed fluid flows of different temperatures may be shown as two small arrows next to each other. The following is further logical for the person skilled in the art.

FIG. 7A shows an application in which two, in particular continuous, fluid flows are mixed as a function of the rotational position of the valve slide 50. Between the ports 21 and 22 and between the ports 23 and 24, a fluid flow entering the port 22 and/or 24 is guided in each case. For example, the ports 23 and 24 lead as a circuit - in particular exclusively - to a battery, whereby the ports 21 and 22 are intended to fluidically connect a heat source and/or sink to this battery depending on the temperature. The two fluid flows are in principle separated from each other by the valve slide 50, in particular in its first rotational position P1, whereby leakage between two fluid areas B1, B2 is optionally possible. The fluid flows each pass through one of the two fluid areas B1 and/or B2. In the first rotational position P1, essentially complete recirculation can take place in the circuit with the battery and/or via the ports 23 and 24. Between the ports 21 and 22, only a forwarding and/or recirculation of the, for example, cooler fluid flow takes place; this can be understood as a bypass.

When the valve slide 50 is rotated counterclockwise, the fluid areas B1 and B2 are shifted relative to the ports 21, 22, 23, 24, so that switching and/or mixing can be achieved. In the center of FIG. 7A, a rotational position between the first P1 and the second P2 rotational position is shown, in which the fluid flows are mixed, so that the battery fluidly connected to port 23 is supplied with a portion of the fluid, for example cooler fluid, from port 22 and with a portion of the fluid to be cooled from port 24, depending on the temperature. In this respect, the remaining part of the fluid flows entering ports 22 and 24 emerges from port 21. Obviously, the two fluid flows are partially combined and/or mixed in order to exit the ports 23 and/or 21 in a mixed state.

Finally, the second rotational position P2 is shown on the right in FIG. 7A, in which the fluid flows between the respective ports have been completely switched over; here, the battery is at least essentially supplied exclusively with the cool fluid, for example for maximum cooling capacity.

FIG. 7B shows an application in which a fluid flow is divided and/or switched, in particular where a bypass is successively throttled depending on the temperature and finally closed. In particular, it is the case here that a fluid flow is only selectively guided between the ports 21 and 22, for example with no passage between the ports 21 and 22 in the first rotational position P1. In the first rotational position P1, a second end flank 62 may cover the port 21 and/or the opening 48 to prevent flow or backflow. For example, the ports 21 and 22 lead to a heat exchanger through which fluid flow is only directed when the fluid flow directed to the port 24 is switched via the rotation of the valve slide 50. In this respect, ports 23 and 24 can connect a heat source to be cooled to the heat exchanger depending on the temperature. In the first rotational position P1, ultimately no fluid flow flows in the fluid area B1 and the fluid flow entering the port 24 is routed directly back to the port 23 via the fluid area B2 as a bypass, see FIG. 7B left.

When the valve slide 50 is rotated counterclockwise, the fluid areas B1 and B2 are displaced relative to the ports 21, 22, 23, 24 in order to successively throttle and/or close the bypass. A rotational position between P1 and P2 is shown in the center of FIG. 7B, wherein the heat exchanger is at least partially connected to the fluid flow entering port 24, and wherein a portion of the fluid flow entering port 24 is somewhat throttled at port 23 and thus partially returned directly to port 23. Another part of the fluid flow entering port 24 can exit port 21, so that an inlet of a corresponding fluid flow can be obtained at port 22 into the first fluid area B1. Here, it is the case that the flow rate and/or the volume flow of fluid through the heat exchanger can be adjusted as a function of the rotational position of the valve slide 50, for example to avoid unnecessary frictional losses or to control a jerk. Furthermore, the second flanks 62 prevent the fluid entering the fourth port 24 at port 21 from reaching the first fluid area B1 directly and/or from flowing back unintentionally over a short distance. Furthermore, the third port 23 is increasingly closed on the part of the second fluid area thanks to a second flank 62 with rotation in the direction of the second rotational position P2.

Finally, the second rotational position P2 is shown on the right in FIG. 7B, in which the bypass is closed and only the heat exchanger connected to port 21 is supplied with fluid from port 24.

With reference to FIGS. 8A-B, the operation of a valve device 10 with a cam and with the valve slide 50 of FIGS. 4 and/or 5 can be understood. The valve slide 50 is rotated by means of the rotation of the cam as part of the adjustment element 82. The cam can be rotated via the drive motor 84 not shown here. Turning clockwise, the cam can stop at the adjustment element stop 44, for example for referencing. Turning counterclockwise, the cam can deflect the valve slide 50 by sliding against it. The valve slide 50 is subjected to force in the opposite direction via the return element 81, so that when the valve slide 50 is turned clockwise, it is also ensured that the valve slide 50 follows.

FIGS. 8A-B is/are in principle to be described analogously to FIGS. 7A-B, so that reference is made to these explanations in order to avoid repetition. Deviating from this is the fact that the rotation of the valve slide 50 and/or the temperature-dependent regulation of the rotational position in FIGS. 8A-B is not effected by an expansion element, but by a cam driven by means of a drive motor 84. The drive motor 84 can be configured to rotate the valve slide 50 as a function of a temperature of a fluid flow and/or as a function of a control command.

With reference to FIGS. 9A-C, cascaded valve devices 10 are shown. Several valve devices 10, 10' can be used redundantly or in a complementary manner. For example, valve devices 10, 10' can be connected in series for switching and/or mixing more than two fluid flows, see FIG. 9A. For example, valve devices 10, 10' can be connected to each other in an interlocking manner via mounting elements 49, see FIG. 9B. For example, valve devices 10, 10' can be connected in parallel to increase flow rates, see FIG. 9C.

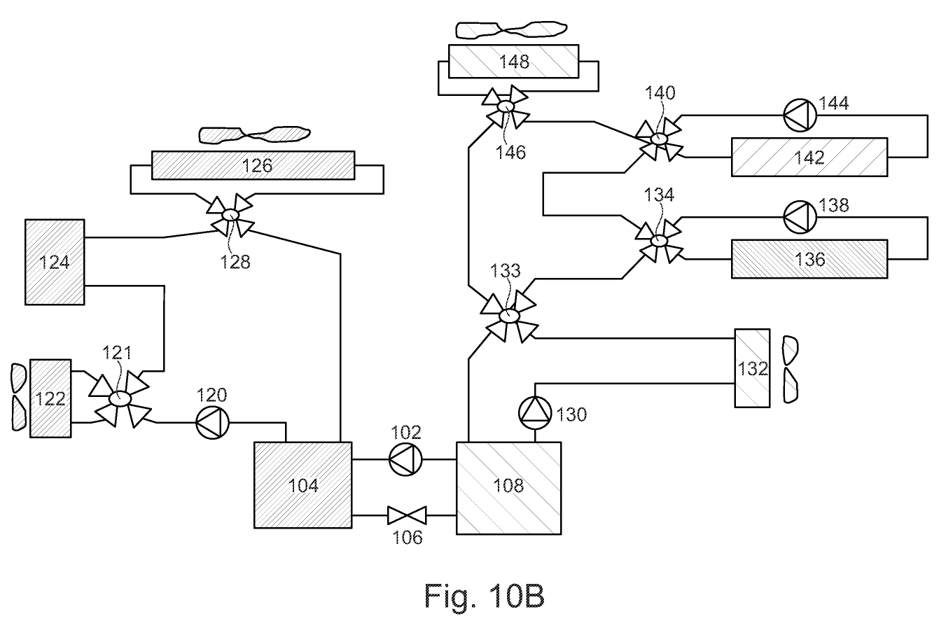

With reference to FIGS. 10A-B, a thermal management system of an electrified vehicle is shown as a schematic circuit diagram. The vehicle can be a battery electric and/or hybrid vehicle. A battery 136 is provided for storing electrical energy that can be used to propel and/or drive the vehicle. The battery 136 comprises, for example, an energy capacity of at least 1 kWh, possibly at least 10 kWh. An electronic system 142 is provided for controlling a charging process and/or discharging process of the battery 136 and/or for controlling an electric drive motor of the vehicle fed by the battery 136. The vehicle comprises a passenger cabin, not shown in detail, which can be heated by a heater 122. Pumps 120, 130, 138, 144 may circulate fluid flows between the components of the respective thermal management system. Fluid flows and/or fluids can transport heat and may comprise or consist of a liquid. Aqueous, oil-containing and/or refrigerant-containing fluids may be provided as fluids.

At various heat exchangers 122, 126, 132 and/or 148 in the thermal management system (see FIGS. 10A-B), heat can be dissipated to the ambient air, in particular by means of . In particular, the heat exchanger(s) 122, 126, 132 and/or 148 are water/air heat exchangers. A propeller and/or fan is shown schematically in each case to indicate that convection of the ambient air can be forced.

The thermal management system comprises a hot side (left in FIGS. 10A-B) and a cold side (right in FIGS. 10A-B). The hot side and the cold side are connected by a heat pump circuit. The heat pump circuit comprises a compressor 102, a condenser 104, an expansion valve 106 and a heat exchanger 108. A refrigerant, which can assume a gaseous and/or a liquid state, is guided in the heat pump circuit. The heat exchanger 108 can exchange heat between the refrigerant and a fluid, in particular a liquid fluid, and/or between the fluid flows. The heat exchanger 108 works in conjunction with the compressor 102 and the expansion valve 106. The compressor 102 compresses a refrigerant, causing it to heat up. After the refrigerant comprises been cooled by the condenser 104, it enters the expansion valve 106, where it rapidly expands and cools down considerably. This cooling process is then used to lower the temperature of liquids in the heat exchanger 108.

The hot side in FIG. 10A is connected to the condenser 104 to utilize and optionally remove heat from the condenser 104 from the compressed refrigerant. The hot side comprises a pump 120 which supplies hot fluid to the passenger cabin heater 122, an oil/water heat exchanger 124, a valve device 128 and optionally a low temperature heat exchanger 126. The fluid may be liquid and may include, for example, an aqueous and/or water-based heat transfer medium. The valve device 128 is configured to supply the heat exchanger 126 in a temperature-dependent manner in order to adjust a temperature of the fluid flow returned to the condenser 104, for example. For example, if the temperature is too high, the heat exchanger 126 can be partially or completely included into it and/or the fluid flow can be partially or completely switched into it. The heat exchanger 126 can then dissipate the heat of the fluid to the ambient air, for example.

In the thermal management system in FIG. 10B, in a modification of FIG. 10A, a further valve device 121 is implemented on the hot side, namely to supply the heater 122 only optionally, for example not at all, partially or completely, with the warm fluid flow coming from the condenser 104. The valve device 121 may provide a bypass, in particular to the heater 122, for example to influence the temperature of the fluid flowing to the heat exchanger 124 and/or to the heat exchanger 126 and/or to the condenser 104.

The valve device 121 and/or 128 (cf. FIGS. 10A-B) may be, for example, that of FIGS. 7B or 8B, wherein the heater 122 and/or the heat exchanger 126 may be connected to the ports 21, 22. An actuation mechanism of the respective valve device 121 and/or 126 may comprise a drive motor and/or an expansion element.

The cold side in FIG. 10A is connected to the heat exchanger 108 in order to use its reduced temperature and/or reduced heat originating from the expanded refrigerant for temperature control and, if necessary, to dissipate it. The cold side comprises a pump 130 which in principle supplies a heat exchanger 132, valve devices 134, 140 and 146 and optionally a battery 136, electronics 142 and a low temperature heat exchanger 148. The valve devices 134, 140 and 146 are each configured to switch and/or mix depending on the temperature. For example, the battery 136 and the electronics 142 are each exposed to a continuous fluid flow via their own pumps 138 and/or 144, to which the cooler fluid flow from the heat exchanger 108 is only optionally added or replaced via the valve devices 134 and/or 140. The valve device 146 is configured to supply the heat exchanger 148 in a temperature-dependent and/or switched manner by a control command in order to adjust a temperature of the fluid flow, for example returned to the heat exchanger 108. For example, when the temperature of the fluid flow is increased relative to the ambient air, the heat exchanger 148 can be partially or completely looped in and/or the fluid flow can be switched into it. The heat exchanger 148 can supply the heat of the fluid to the ambient air and/or cool the fluid if it is necessary or useful, depending on the intended use.

In the thermal management system in FIG. 10B, in a modification of FIG. 10A, a further valve device 133 is implemented on the cold side, namely in order to supply the circuit downstream of the heat exchanger 132, in the present case including battery 136, electronics 142 and heat exchanger 148, only optionally, for example not at all, partially or completely, with the cold fluid flow coming from the heat exchanger 108 and/or to operate it without the heat exchanger 108 of the heat pump circuit and/or the heat exchanger 132. The valve device 133 may provide a bypass upstream of the heat exchanger 108 and/or downstream of the heat exchanger 132, for example if cooling of the battery 136 and/or electronics 142 is not currently required or if the temperature of the fluid flow from the heat exchanger 108 needs to be further reduced as quickly as possible.

The valve device 133 (see FIG. 10B) makes it possible to create a bypass away from the heat exchanger 108 and/or heat pump circuit. For example, this is provided when the vehicle is at a standstill, the battery 142 is being charged and the electronics 136 and/or battery 142 generate waste heat and/or need to be tempered. In particular, the heat pump circuit can be kept out of operation. In this respect, electronics 136 and/or battery 142 can be tempered with the aid of the heat exchanger 148 and possibly the valve device 146, in particular without the heat exchanger 108 assisting with tempering.

For example, the valve device 133 (see FIG. 10B) can provide a bypass during a cold start, for example so that the battery 136 and/or the electronics 142 can heat up quickly on their own. The bypass can then be successively closed in order to temper the battery 136 and/or the electronics 142 through a fluidic connection to the heat exchanger 108.

The valve device 146 (cf. FIGS. 10A-B) can be, for example, that of FIGS. 7B or 8B, whereby the heat exchanger 148 can be connected to the ports 21 and 22. An actuation mechanism of the valve device 146 may comprise a drive motor and/or an expansion element. In particular, the valve device 146 can be switched, for example by means of the drive motor, by a control command, for example if the fluid flow coming from the electronics 136 and/or battery 142 is to be cooled by means of the heat exchanger 148.

The valve device 134 and/or 140 (cf. FIGS. 10A-B) can be, for example, that of FIGS. 7A or 8A, whereby the battery 136 and/or the electronics 142 can be connected to the ports 21 and 22 or also the ports 23 and 24 of the respective valve device 134 and/or 140.

The valve devices 10, 121, 128, 133, 134, 140, 146 described herein can be used as mixing valves for supplying different temperature levels (see, for example, FIGS. 7A or 8A) and/or as flow dividers for dividing between radiator flow and bypass (see, for example, FIGS. 7B or 8B).

The described thermal management systems of FIGS. 10A-B comprise valve devices 121, 128, 133, 134, 140, 146, heat sources and/or heat sinks and pumps for providing fluid flows. The condenser 104, the heat exchangers 108, 124, 126, 132, 148, the battery 136, the electronics 142, the heat pump circuit and/or the heater 122 may be configured and/or considered as heat sources and/or heat sinks, as they can/must emit heat or absorb heat, for example to ensure proper functioning of the thermal management system or to fulfill external requirements, for example heating of the passenger cabin, temperature control of the battery 136 or others.

The valve devices 121, 128, 133, 134, 140, 146 are at least partially configured to supply a heat source and/or heat sink connected thereto with the fluid flow as a function of a temperature of the fluid flow. It is also possible to implement the supply as a function of control commands and/or external requirements.

The described thermal management systems represents a use of the valve devices 121, 128, 133, 134, 140, 146 for switching and/or mixing a fluid flow and/or a plurality of fluid flows in an electrified vehicle.

Disclosed is a method for switching and/or mixing fluid flows between at least two ports 21, 22, 23, 24 of the valve device 10, wherein the valve slide 50 of the valve device 50 is rotated as a function of a temperature of a fluid flow flowing in particular through the valve device 10 and/or as a function of a control command.

1. A valve device for a fluid flow, the valve device comprising:
a housing with a fluid chamber delimited by an inner surface of the housing and with at least two ports opening into the fluid chamber,
a valve slide arranged rotatably about a rotation axis in the fluid chamber, wherein the valve slide divides the fluid chamber into at least two fluid areas, and wherein the valve slide bears against the inner surface at least in sections to seal the fluid areas with respect to one another, and
an actuation mechanism arranged at least partially in the fluid chamber for rotating the valve slide.

2. The valve device of claim 1,
wherein the valve slide includes a first wall section, a second wall section, and a bearing section between the two wall sections,
wherein the first wall section and the second wall section are arranged facing away from each other, and
wherein the bearing section defines the rotation axis or coincides with the rotation axis.

3. The valve device of claim 2,
wherein the inner surface in a first inner surface section is shaped substantially round or cylindrical about the rotation axis and the at least two ports extend from the first inner surface section.

4. The valve device of claim 3,
wherein the inner surface includes a second inner surface section and a third inner surface section which face each other, and to which the valve slide and the first inner surface section are adjacent.

5. The valve device of claim 4,
wherein the first inner surface section and the second inner surface section are provided by a first housing section of the housing, and
wherein the third inner surface section is provided by a second housing section of the housing or a first housing section of a housing of an identical valve device.

6. The valve device of claim 4,
wherein the valve slide bears against the first inner surface section, the second inner surface action, and the third inner surface section, and
wherein the valve slide includes a sealing portion for sealing, which is formed integrally with the valve slide or is attached thereto, and
wherein the housing and the valve slide each comprise or are formed from at least one of a polymer compound and a metal material.

7. The valve device of claim 3,
wherein the valve slide includes at least one first end flank which is at least substantially linearly adjacent to the first inner surface section, and
wherein at least one of the first wall section or the second wall section includes one of the at least one first end flank.

8. The valve device of claim 3,
wherein the valve slide includes at least one second end flank which at least substantially flatly adjoins the first inner surface section and extends at least substantially in a circumferential direction about the rotation axis.

9. The valve device of claim 8,
wherein the first wall section and the second wall section each include one of the at least one second end flank, and
wherein the two second end flanks point in the same direction in the circumferential direction.

10. The valve device of claim 8,
wherein the at least one second end flank includes a recess extending in the circumferential direction about the rotation axis.

11. The valve device of claim 1,
wherein the housing includes at least one stop against which the valve slide abuts to define a first rotational position of the valve slide.

12.The valve device of claim 1,
wherein the at least two ports open into the fluid chamber spaced apart from each other in a circumferential direction about the rotation axis, and
wherein an angle between two ports adjacent in the circumferential direction about the rotation axis is at least 10 degrees and up to 170 degrees.

13. The valve device of claim 1,
wherein a first port and a second port of the at least two ports are arranged at least substantially parallel to each other and facing away from each other.

14. The valve device of claim 13,
wherein a third port and a fourth port of the at least two ports are arranged pointing at least substantially in the same direction or crosswise to the first port or the second port.

15. The valve device of claim 1, wherein at least one of:
a first port is configured to correspond to a second port to fluidically and mechanically connect two identical valve devices through the first and the second port of the two identical valve devices; and
a first housing section of the housing, facing away from the fluid chamber is configured to correspond mechanically to a second housing section of the housing to stack two identical valve devices with coaxially arranged rotation axes in an interlocking manner.

16. The valve device of claim 1,
wherein the actuation mechanism is configured to rotate the valve slide starting from a first rotational position in the direction of a second rotational position and includes an adjustment element bearing against the valve slide away from the rotation axis and supported against the housing, and wherein
the adjustment element is configured to rotate the valve slide as a function of a rotation of the adjustment element, or is configured to rotate the valve slide as a function of a temperature and includes an expansion element.

17. The valve device of claim 16,
wherein the actuation mechanism includes a return element arranged in the fluid chamber, which is configured to return the valve slide in the direction from the second to the first rotational position,
wherein the return element is configured to act on the valve slide radially spaced from the rotation axis.

18. The valve device of claim 16,
wherein the actuation mechanism includes a drive motor which is arranged outside the fluid chamber and which is non-rotatably connected to the adjustment element for rotating the adjustment element, and
wherein the adjustment element is guided fluid-tightly and rotatably through a passage of the housing.

19. A thermal management system for an electrified vehicle, the thermal management system comprising:
a valve device including:
a housing with a fluid chamber delimited by an inner surface of the housing and with at least two ports opening into the fluid chamber,
a valve slide arranged rotatably about a rotation axis in the fluid chamber, which valve slide divides the fluid chamber into at least two fluid areas, and which valve slide bears against the inner surface at least in sections to seal the fluid areas with respect to one another, and
an actuation mechanism arranged at least partially in the fluid chamber for rotating the valve slide,
at least one of a heat source and a heat sink, and
a pump for providing a fluid flow,
wherein the valve device is configured to supply the heat source or the heat sink with the fluid flow as a function of a temperature of the fluid flow.

20. A method for at least one of switching and mixing a fluid flow between multiple ports, the method including:
directing the fluid flow through a valve device including:
a housing with a fluid chamber delimited by an inner surface of the housing and with at least two ports opening into the fluid chamber,
a valve slide arranged rotatably about a rotation axis in the fluid chamber, which valve slide divides the fluid chamber into at least two fluid areas, and which valve slide bears against the inner surface at least in sections to seal the fluid areas with respect to one another, and
an actuation mechanism arranged at least partially in the fluid chamber for rotating the valve slide, and
rotating the valve slide as a function of a temperature of a fluid flow, wherein the fluid flow includes a liquid.
